(19) United States
(12) Patent Application Publication
(10) Pub. No.: US 2015/0085464 A1
(43) Pub. Date: Mar. 26, 2015

(54) LIGHT EMITTING DEVICE

(71) Applicant: NEC CORPORATION, Tokyo (JP)

(72) Inventor: Naofumi Suzuki, Tokyo (JP)

(73) Assignee: NEC CORPORATION, Tokyo (JP)

(21) Appl. No.: 14/386,683

(22) PCT Filed: Mar. 5, 2013
(86) PCT No.: PCT/JP2013/001366

§ 371 Date: Sep. 19, 2014

(30) Foreign Application Priority Data
Mar. 22, 2012 (JP) 2012-066083

(51) Int. Cl. F21V 8/00; F21V 9/14

(52) U.S. Cl. CPC G02B 6/0046; F21V 9/14
USPC 362/19; 362/606

(57) ABSTRACT

A light emitting device of the present invention comprises a light source and an optical filter and is characterized by that it further comprises a first light guiding member of a taper shape whose cross-sectional area is gradually increased and a second light guiding member whose flare angle is smaller than that of the taper shape of the first light guiding member, wherein the length of the second light guiding member is smaller than the first light guiding member.

### TECHNICAL FIELD

The present invention relates to a light emitting device which is used as a light source in a video system.

### BACKGROUND ART

In recent years, the performance of video systems such as large-size displays and projectors has been greatly improved.

A light source used in such video systems is desired to have high efficiency, high output power and high brightness, and additionally, it is also desired to generate light in a certain specific state. The specific state means such as a state where polarization of the light is uniform or a state where the light is distributed within a comparatively small certain radiation angle.

Here, the polarization state will be described taking it as an example. A liquid crystal display device widely employed for the use such as in a flat display includes a polarizer on each of the light input side and the light output side, such that its transmittance of light to the light output side is controlled by applying a voltage to a liquid crystal sandwiched between the polarizers, and thereby controlling the polarization rotation.

Out of light inputted from the light source to the liquid crystal display device, a portion linearly polarized in a certain direction is utilized by being transmitted through the input side polarizer, and any portions having other polarization states are not utilized.

Accordingly, when light emitted from the light source is non-polarized light including polarization states in all directions, a proportion of light to be transmitted through the input side polarizer and consequently be able to be utilized is limited to be at most 50%.

On the other hand, when light emitted from the light source is linearly polarized light, a proportion of light to be able to be utilized is up to 100%. Therefore, the efficiency of light usage can be greatly raised in the case of linearly polarized light, compared to the case of non-polarized light, and accordingly, power saving of the video system becomes possible.

As a technology for generating linearly polarized light, there is a light source obtained by combining an element for emitting non-polarized light, such as a light emitting diode (LED), with a reflective polarizer.

In this technology, a reflective polarizer is located above an LED, and the reflective polarizer transmits linearly polarized light whose polarization direction is that determined by the polarizer and reflects light polarized in a direction perpendicular to the determined one. The reflected light travels back to the LED side, is reflected by the LED, and thus becomes incident on the polarizer again. As the reflected light is the light once reflected by the polarizer, it is polarized in a direction perpendicular to the transmission axis of the polarizer.

Accordingly, if the polarization state of the reflected light has not been changed at the time of reflection by the LED, the reflected light is reflected again by the polarizer at the time of its re-incidence on the polarizer. However, if an element for changing the polarization state, such as a wave plate, is provided between the polarizer and the LED, the reflected light is enabled to be transmitted by the polarizer at the time of the re-incidence.

In an alternative case where the LED has an internal mechanism for scattering light, the reflected light should have been changed to be non-polarized light by the scattering mechanism when it was once reflected by the LED. Then, this time, out of the reflected light re-entering the polarizer, a half portion is transmitted by the polarizer and the other half portion is reflected. The other half portion of the reflected light is again changed to be non-polarized light at the time of reflection by the LED. By repeating the process, the above-mentioned technology makes it possible to take out the entire portion of the emitted light in the form of linearly polarized light having a polarization state aligned in a single direction.

In the above-mentioned technology, the reflective polarizer is located immediately to a high brightness LED. Accordingly, the polarizer needs to have lightfastness. Further, the temperature of the high brightness LED significantly rises during the operation. Because the temperature of the high brightness LED is transferred to the polarizer, the temperature of the polarizer also rises. In a case a portion of light is absorbed within the polarizer, this absorption changes into heat, and as a result, the temperature of the polarizer further rises. For this reason, the polarizer needs to have heat resistance. Further, emitted light from the LED is radiated at a wide range of angles from 0 to 90 degrees. Accordingly, the polarizer is required to hold characteristics of a certain degree or higher over the wide range of angles. That is, the polarizer needs to have tolerance to a wide range of incident angles.

However, it is difficult to satisfy all of these requirements simultaneously.

For example, a wire-grid type polarizer formed by periodically arranging fine metal threads with a smaller width than the wavelength of light has lightfastness and heat resistance, but its transmittance decreases with increasing the incident angle of light. Similarly, a polarizer made of a dielectric material having a fine structure has excellent lightfastness and heat resistance, but its incident angle tolerance is narrow. On the other hand, a polarizer made of an organic film has good incident angle tolerance, but its lightfastness and heat resistance are insufficient so that its property is altered to cause degradation in the characteristics when used in the close vicinity of the LED.

In another technology, for the purpose of solving such a problem, a taper rod is disposed immediately to an LED, and a reflective polarizer is disposed at the top of the taper rod. The taper rod is made from a transparent medium such as glass. The taper rod is a light guiding member with a taper shape whose cross-section gradually increases in the direction from the incidence side to the emission side. Emitted light from the LED is incident on the taper rod. Light having entered the taper rod repeats total reflection at the side surface of the taper rod and then reaches the emission side.

While the light having entered the taper rod is radiated from a wide emission surface when it is guided through the taper rod, the radiation angle of the light becomes smaller at the same time. For example, considered here is a case where the cross-sectional area of the emission surface of the taper rod is four times that of the incidence surface. While the emitted light from the LED has a wide angle range from 0 to 90 degrees, the light radiated from the emission surface of the taper rod comes to have ideally a narrow angle range from 0 to about 30 degrees. This angle range lies within the incident angle tolerance of the above-mentioned wire-grid type polarizer and fine-structured dielectric polarizer. The polarizer is located away from the LED. In addition to that, the light passing through the taper rod is to be radiated from the wide emission surface, and therefore, the illuminance on the polarizer is decreased. As a result, requirement for lightfastness and heat resistance of the polarizer is relaxed. In this technology, a polarizer made of an organic film may be used depending on conditions. Further, in order to prevent leakage of light, the reflective polarizer is located immediately to the emission surface of the taper rod or in a manner to be closely contact with the surface.

A detail description will be given below of a state of reflection of light within a taper rod, using drawings.

FIG. 3 is a plan view of parallel rod showing a state of reflection of light within a parallel rod without taper.

In the parallel rod 300, an incidence surface 310 and an emission surface 320 are parallel to each other, and the cross-sectional area of the emission surface 320 is the same as that of the incidence surface 310. The direction perpendicular to these surfaces is assumed to be the z-axis direction, and a direction parallel to them to be the x-axis direction.

Light having entered through the incidence surface 310 from an oblique direction travels in the z-axis direction, repeating reflection at side surfaces 330 and 335.

When the ratio of the refractive index of the parallel rod 300 to that of the surrounding medium is equal to or larger than a certain value, the incident angle θ on the side surface 330 becomes equal to or larger than the critical angle θc for any value of the incident angle Φ on the incidence surface 310, and accordingly, the light is totally reflected at the side surface 330.

As a result, the light is propagated without leaking out of the parallel rod 300. Even when the light is reflected a plurality of times by the side surfaces 330 and 335, the incident angle θ on the side surfaces 330 and 335 is constant and accordingly is always equal to or larger than the critical angle θc.

FIG. 4 is a plan view of taper rod showing a state of reflection of light within a taper rod with taper.

In the taper rod 400, an incidence surface 410 and an emission surface 420 are parallel to each other, but the cross-sectional area of the emission surface 420 is larger than that of the incidence surface 410. The direction perpendicular to these surfaces is assumed to be the z-axis direction, and a direction parallel to them to be the x-axis direction. The taper angle of the taper rod 400 is α.

Considering a case of directional lines in FIG. 4 where the light travels in a direction of increasing the cross-sectional area, that is, a direction from the incidence surface 410 toward the emission surface 420, the incident angle of the light on the side surface 430 is increased by α to be θ+α each time the light is reflected at the side surface 430. Accordingly, a margin with respect to the critical angle θc is increased.

In the technology described above, an optical filter such as a reflective polarizer is disposed on the side of the emission surface 420 of the taper rod 400. By thus disposing the reflective polarizer, a light component having polarization perpendicular to the transmission axis of the polarizer is reflected at the side of the emission surface 420 and then travels back to the side of the incidence surface 410. That is, the light reflected at the side of the emission surface 420 traces an optical path, shown in FIG. 4, in which light enters from the incidence surface 410, is then reflected at the emission surface 420 and travels back toward the incidence surface 410. Light having returned to the side of the incidence surface 410 becomes incident on an LED being a light source, and it is reflected there. If an element for changing a polarization state, such as a wave plate, is disposed, or the LED has an internal mechanism of scattering light, it becomes possible to increase the efficiency of light usage, similarly to the above-described case where a reflective polarizer is disposed immediately to the LED.

Technologies in which the efficiency of light usage is increased by the use of a taper rod and a reflective polarizer are described in Patent Document 1 (Japanese Patent Publication No. 3991764), Patent Document 2 (Japanese Patent Application Laid-Open No. H11-142780) and Patent Document 3 (Japanese Patent Application Laid-Open No. 2006-220911).

These technologies using a taper rod, just mentioned above, have a problem in that the efficiency of light usage is low because of a large amount of light leakage. The reason of a large amount of light leakage is as follows.

The description of the above-mentioned background technology using a taper rod will be continued below. When a reflective polarizer is disposed as described above, the light reflected at the side of the emission surface 420 traces an optical path, shown in FIG. 4, in which light enters from the incidence surface 410, is then reflected at the emission surface 420 and travels back toward the incidence surface 410. This optical path for traveling back is of a case which is opposite to that of the directional lines in FIG. 4. In the present case, the incident angle of the light on the side surface 430 is decreased by α each time the light is reflected at the surface 430. Accordingly, a margin with respect to the critical angle θc is decreased. Light with an incident angle not smaller than the critical angle θc is reflected at the side surfaces 430 and 435. However, if the number of incidences onto the side surfaces during travelling from the emission surface 420 to the incidence surface 410 becomes larger than that during travelling from the incidence surface 410 to the emission surface 420, there may occur a case where the incident angle on the side surfaces is smaller than the critical angle θc and accordingly the condition for total reflection is not satisfied. In that case, there occurs leakage of light through the side surfaces to the outside.

What difference in the number of incidences onto the side surfaces between the forward path and the backward path could make the condition for total reflection unsatisfied is dependent on the taper angle α, the incident angle θ and the refractive index n of the taper rod. For a constant value of the incident angle θ, an enough difference in the number of reflections to make the incident angle on the side surfaces smaller than the critical angle θc can be reduced by decreasing the taper angle α and increasing the refractive index n. When the taper angle α is decreased, the length of the taper rod needs to be increased so as to realize a constant area ratio between the incidence surface and the emission surface. However, increasing the length of the taper rod causes a problem in that the production cost of the rod is increased and device size reduction is prevented. On the other hand, increasing the refractive index n of the taper rod can be considered to be another way. However, the cost of a medium with a high refractive index is generally higher than that of usual glass. Further, absorption at short wavelengths tends to increase with increasing the refractive index. The absorption becomes a problem when a relatively long element such as the taper rod is produced. Further, as a result of decrease in the incident angle of light within the medium and consequent decrease in the number of incidences onto the side surfaces, it becomes highly possible that light with an insufficiently narrow angle is generated. That is, the angular distribution of emitted light comes to have a shape slightly trailing into the high angle side. For this reason, to obtain a radiation angle distribution equivalent to that obtained by usual glass, the length of the taper rod needs to be increased. However, as already described above, increasing the length of the taper rod causes a problem in that the production cost of the rod is increased and device size reduction is prevented.

In another respect, light leakage through the side surfaces can be greatly reduced by forming a reflection film made of a dielectric multilayer film onto the side surfaces of the taper rod. However, when a dielectric multilayer film is formed onto the whole of the side surfaces, the production cost of the taper rod greatly increases.

The objective of the present invention is to provide a light emitting device which solves the problem described above.

### DESCRIPTION OF INVENTION

A light emitting device of the present invention comprises a light source and an optical filter, and is characterized by that it further comprises a first light guiding member of a taper shape whose cross-sectional area is gradually increased and a second light guiding member whose flare angle is smaller than that of the first light guiding member, wherein the length of the second light guiding member is smaller than that of the first light guiding member.

### BRIEF DESCRIPTION OF DRAWINGS

FIG. 1 is a diagram showing a configuration of a light emitting device according to a first exemplary embodiment of the present invention.

FIG. 2 is a diagram showing relationships between the lengths of a taper rod and a parallel rod and light returning back to a light source after travelling forward and then backward within the rods.

FIG. 3 is a plan view of parallel rod showing a state of reflection of light within a parallel rod without taper.

FIG. 4 is a plan view of taper rod showing a state of reflection of light within a taper rod with taper.

FIG. 5 is a plan view of taper rod showing another state of reflection of light within the taper rod with taper.

FIG. 6A is a plan view of rod showing a state of reflection of light within a rod comprising a taper rod and a parallel rod.

FIG. 6B is a plan view of rod showing another state of reflection of light within the rod comprising a taper rod and a parallel rod.

FIG. 7 is a diagram showing a configuration of a light emitting device according to a second exemplary embodiment of the present invention.

FIG. 8 is a diagram showing a configuration of a light emitting device according to a third exemplary embodiment of the present invention.

FIG. 9 is a plan view of light guiding member showing a structure of a light guiding member of a light emitting device according to a fourth exemplary embodiment of the present invention.

FIG. 10 is a plan view of light guiding member showing a structure of a light guiding member of a light emitting device according to a fifth exemplary embodiment of the present invention.

FIG. 11 is a plan view of light guiding member showing a structure of a light guiding member of a light emitting device according to a sixth exemplary embodiment of the present invention.

FIG. 12 is a plan view of light guiding member showing a structure of a light guiding member of a light emitting device according to a seventh exemplary embodiment of the present invention.

FIG. 13 is a plan view of light guiding member showing a structure of a light guiding member of a light emitting device according to an eighth exemplary embodiment of the present invention.

### DESCRIPTION OF EMBODIMENTS

Hereinafter, exemplary embodiments of the present invention will be described using drawings. It should be noted that, although restrictions preferable for implementing the present invention from the technical aspect will be applied to the exemplary embodiments described below, the scope of the present invention is not limited to the following exemplary embodiments.

### First Exemplary Embodiment

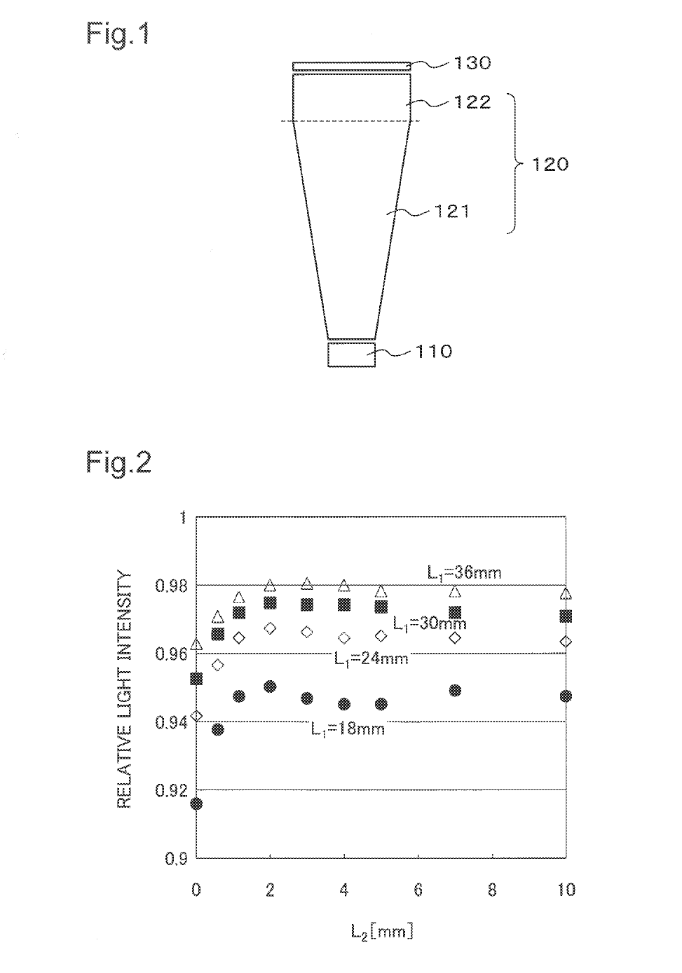

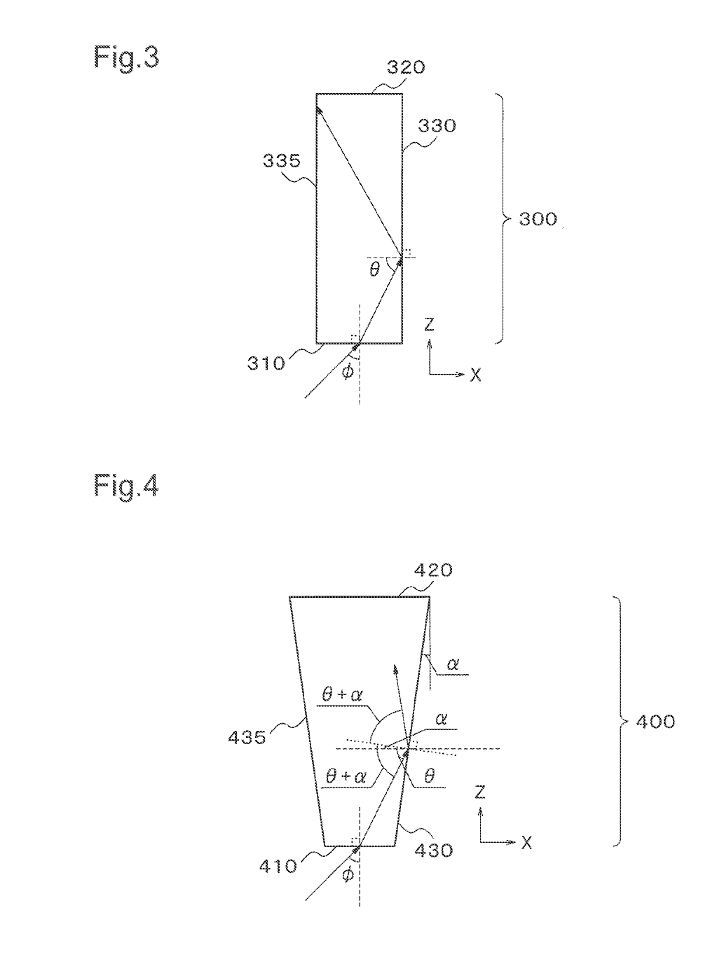

The present exemplary embodiment will be described in detail with reference to drawings. FIG. 1 is a diagram showing a configuration of a light emitting device according to a first exemplary embodiment of the present invention.

[Description of Structure]

As shown in FIG. 1, the present exemplary embodiment of the invention comprises a light source 110, a light guiding member 120 and an optical filter 130. The light source 110 comprises a light emitting diode (LED), the light guiding member 120 comprises a first light guiding member 121 and a second light guiding member 122, and the optical filter 130 comprises a reflective polarizer. The components are arranged to be close to each other. An antireflection coating is formed onto both of the surfaces of the light guiding member 120 and those of the reflective polarizer.

The first light guiding member 121 is a taper rod with taper whose cross-sectional area gradually increases in the direction from the incidence surface toward the emission surface. The taper angle of the first light guiding member 121 is α.

The second light guiding member 122 is a parallel rod whose cross-sectional area is constant in the direction from the incidence surface toward the emission surface. The taper angle of the second light guiding member 122 is smaller than that of the first light guiding member 121, α.

The light emission area of the LED is 3.2 mm×1.8 mm, the incidence area of the light guiding member on the side of the light source 110 is 3.2 mm×1.8 mm, and the radiation area on the side of the optical filter 130 is 6.4 mm×3.6 mm. The length of the taper rod of the first light guiding member 121 is 18 mm. The length of the parallel rod of the second light guiding member 122 is 2 mm. The refractive index of the light guiding member 120 is 1.5.

[Description of Operation and Effect]

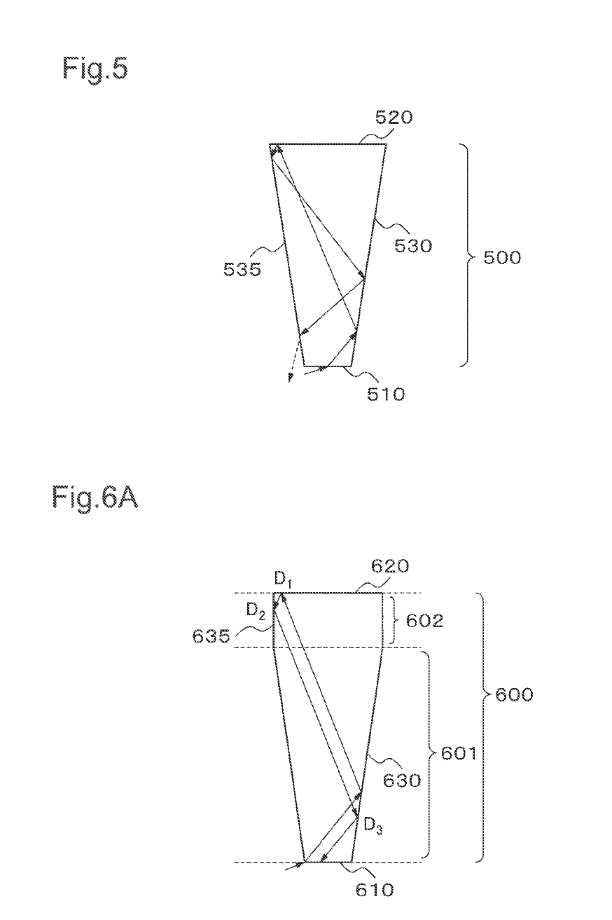

Next, leakage of light at the light guiding member will be described in detail, using drawings. FIG. 5 is a plan view of taper rod showing a state of reflection of light within a taper rod with taper. A taper rod 500 shown in FIG. 5 is a taper rod with taper whose cross-sectional area gradually increases in the direction from the incidence surface to the emission surface. A case assumed here is one in which a wavelength filter (not illustrated) is directly formed onto the emission surface 520. Among light beams reflected by the filter formed on the emission surface 520, a light beam reflected at a position near the boundary of the side surface 535 by the reflective polarizer, as shown in FIG. 5, has a highest possibility to cause leakage of light. In the case of such a light beam, light reflected at the emission surface 520 and then travelling toward the side of the incidence surface 510 is to be reflected at the side surface 535 immediately after the reflection at the emission surface 520. Because the incident angle of light after the reflection at the side surface 535 is decreased by α, a travelling distance of the light toward the incidence surface 510 until its next incidence on the side surface 530 becomes smaller. As a result, the number of the light's incidences on the side surfaces 530 or 535 increases. When the number of incidences on the side surfaces 530 or 535 thus increases, there may occur a case where the incident angle of light on the side surfaces becomes smaller than the critical angle θc and accordingly comes not to satisfy the condition for total reflection. In that case, a portion of the light leaks out through the side surfaces.

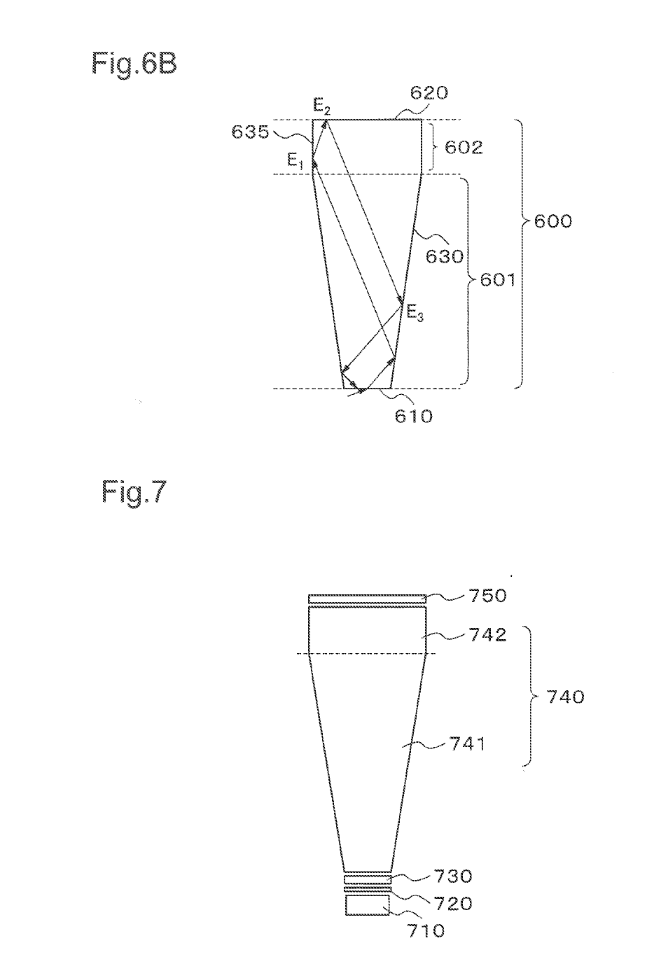

FIGS. 6A and 6B are plan views of rod showing a state of reflection of light within a rod comprising a taper rod and a parallel rod. A rod 600 shown in FIGS. 6A and 6B comprises a parallel rod 602 on the top of a taper rod 601.

As shown in FIG. 6A, although light reflected at a point D1 in the vicinity of the boundary between an emission surface 620 and a side surface 635 is to be immediately reflected at a point D2 on the side surface 635, the part including the point D2 is that of the parallel rod, and accordingly, the incident angle does not change. Then, a point D3 at which the light becomes incident on a side surface 630 of the taper rod for the first time is a point to be reached after travelling a certain amount of distance toward the side of an incidence surface 610.

As shown in FIG. 6B, light reflected at a point E1 on the side surface 635 is to be reflected at the parallel rod 602, and accordingly, the incident angle does not change. Then, the light is to be immediately reflected at a point E2 on the emission surface 620. Then, a point E3 at which the light becomes incident on the side surface 630 of the taper rod is a point to be reached after travelling a certain amount of distance toward the side of the incidence surface 610.

In both of the cases, in the rod comprising a taper rod and a parallel rod shown in FIG. 6, the number of reflections at the side surfaces of the taper rod to occur during light's travelling from the emission surface to the incidence surface is reduced, compared to in the rod comprising only a taper rod shown in FIG. 5. As a result, the rate of the incident angle becoming smaller than the critical angle is reduced, and accordingly, the proportion of light leaking out through the side surfaces is reduced.

Next, overall operation of the light emitting device of the present invention will be described in detail.

In the present invention, light emitted from the LED light source 110 (expressed as the LED 110, hereafter) passes through the light guiding member 120 (expressed as the rod 120, hereafter) comprising the first light guiding member 121 made of a taper rod (expressed as the taper rod 121, hereafter) and the second light guiding member 122 made of a parallel rod (expressed as the parallel rod 122, hereafter), and then reaches the optical filter 130 made of a reflective polarizer (expressed as the reflective polarizer 130, hereafter). The reflective polarizer 130 transmits light which is linearly polarized in a certain direction and reflects light which is polarized perpendicularly to the direction. The reflected light returns to the LED 110 after passing through the rod 120. A convex-concave structure called a textured structure is formed on the surface of the LED 110. The textured structure is a widely used structure for the purpose of increasing the efficiency of extracting light from an LED. This textured structure cancels the polarization state of the light having returned to the LED 110. That is, the reflected light is changed to be non-polarized light similar to the light at the time of being emitted from the LED 110. After reflected at the LED 110, the light travels again within the rod 120 toward the reflective polarizer 130. By repeating this process, almost whole light is taken out in the form of linearly polarized light from the reflective polarizer 130, in the present structure. In the present structure, light travels forward and backward repeatedly between the LED 110 and the reflective polarizer 130, passing through the rod 120.

Next, a detail description will be given of improvement of the efficiency of light usage in the light emitting device of the present invention. FIG. 2 is a diagram showing relationships between the lengths of the taper rod and the parallel rod and light returning back to the light source after travelling forward and then backward within the rods. FIG. 2 shows results of calculation under the following conditions.

In FIG. 2, L1 is the length of the taper rod. L2 is the length of the parallel rod. The incidence area of the rod is 3.2 mm×1.8 mm, and the emission area is 6.4 mm×3.6 mm. The area of the light source is the same as the incidence area of the rod. The luminance of the light source is assumed to be uniform over the surface. It is also assumed that light emitted from the light source is of angles ranging from 0 to 90 degrees and has a Lambertian distribution. Lambertian is referred to as a case where radiance is constant not depending on direction of observation. The reflectivity of the emission surface is 100%. It is assumed that, onto the incidence surface, an ideal antireflection coating giving zero reflectivity for any incident angles is formed. Light satisfying the condition for total reflection is to be reflected at the incidence surface. It is also supposed that the side surfaces have no antireflection coating. The refractive index of the rod is assumed to be 1.5, and the refractive index of the surround of the rod to be 1. The relative light intensity represented by the vertical axis is the ratio between the amount of light having entered the rod from the light source located immediately before the incidence surface and the amount of light, being a portion of the injected light, reflected at the side of the emission surface of the rod and then returning back to the side of the light source. The relative light intensity becomes larger with decreasing leakage of light, and becomes 1 when there is no leakage.

For the conventional taper rod described above, which has no parallel rod, the taper rod length is 30 mm (L1=30 mm), and the parallel rod length is 0 mm (L2=0 mm). The overall length of the conventional rod is 30 mm. On the other hand, for the rod of the present invention, which has both a parallel rod and a taper rod, the taper rod length is 18 mm (L1=18 mm), and the parallel rod length is 2 mm (L2=2 mm), which is smaller than the length of the taper rod of the present invention. The overall length of the rod of the present invention is 20 mm, which is as small as ⅔ of that of the conventional taper rod.

Then, according to the calculation results of the relative light intensity in FIG. 2, the relative light intensity for the conventional taper rod and that for the rod of the present invention are almost the same.

That is, it is recognized that the rod of the present invention can realize the same degree of efficiency even when its overall length is made as small as ⅔ of the conventional rod.

Considering the case of L1=24 mm and L2=2 mm as another example, the overall length is 26 mm, which is larger than that in the previous example but is still smaller than the length of the conventional taper rod, 30 mm. From FIG. 2, it is recognized that the relative light intensity is larger for the present structure of the another example than for the conventional structure. That is, it is recognized that the present structure realizes a smaller overall length and a higher efficiency, compared to the conventional structure.

From these examples, it is recognized that the rod of the present invention can reduce leakage of light even with a smaller rod length, compared to the conventional taper rod, and accordingly, can realize simultaneous achievement of both size reduction and improvement in efficiency.

### Second Exemplary Embodiment

The present exemplary embodiment will be described in detail with reference to a drawing. FIG. 7 is a diagram showing a configuration of a light emitting device according to a second exemplary embodiment of the present invention.

[Description of Structure]

As shown in FIG. 7, the second exemplary embodiment of the present invention comprises an LED 710, a wavelength filter 720, a phosphor 730, a light guiding member 740 and a reflective polarizer 750. The light guiding member 740 comprises a first light guiding member 741 and a second light guiding member 742. The components are arranged to be close to each other. An antireflection coating is formed onto the both surfaces of the light guiding member 740 and those of the reflective polarizer.

The first light guiding member 741 is a taper rod with taper whose cross-sectional area gradually increases in the direction from the incidence surface toward the emission surface. The taper angle of the first light guiding member 741 is α.

The second light guiding member 742 is a parallel rod whose cross-sectional area is constant in the direction from the incidence surface toward the emission surface. The taper angle of the second light guiding member 742 is smaller than the taper angle of the first light guiding member 741, α.

The light emission area of the LED is 3.2 mm×1.8 mm, the area of the wavelength filter 720 and that of the phosphor 730 are both 3.3 mm×1.9 mm, the incidence area of the light guiding member on the side of the LED 70 is 3.3 mm×1.9 mm, and the emission area on the side of the reflective polarizer 750 is 6.6 mm×3.8 mm.

The length of the taper rod of the first light guiding member 741 is 24 mm. The length of the parallel rod of the second light guiding member 742 is 2 mm. The refractive index of the light guiding member 740 is 1.5.

[Description of Operation and Effect]

In the present structure, light with a peak wavelength of 450 nm is emitted from the LED 710, travels through the wavelength filter 720, and then is absorbed by the phosphor 730. The phosphor 730 excited by this light generates fluorescence with a peak wavelength of 540 nm. The generated fluorescence travels through the light guiding member 740 and then reaches the reflective polarizer 750. The reflective polarizer 750 transmits light which is linearly polarized in a certain direction and reflects light which is polarized perpendicularly to the direction. The reflected light returns to the phosphor 730 after traveling through the light guiding member 740. While a portion of the light entering the phosphor 730 is reflected by the phosphor, the remaining portion passes through the phosphor 730 and then reaches the wavelength filter 720. The wavelength filter 720 is structured in the form of a dielectric multilayer. This dielectric multilayer is designed to transmit light of the wavelength generated by the LED 710 and reflect light of the wavelength generated by the phosphor 730. Accordingly, the fluorescence mentioned above is reflected by the wavelength filter 720, passes through the phosphor 730, and then re-enters the light guiding member 740 and subsequently the reflective polarizer 750. As the light experiences scattering at the time of being reflected by or passing through the phosphor 730, its polarization is cancelled to change the light to be non-polarized light. As a result, out of the light re-entering the reflective polarizer 750, about a half portion is to be transmitted, and the remaining half portion to be reflected. The reflected light travels again toward the side of the LED 710. In the present structure, light travels forward and backward between the wavelength filter 720 and the reflective polarizer 750 in the manner described above, and finally, light which is linearly polarized in a single direction is taken out.

In general, the reflectivity of a wavelength filter can be made higher than that of an LED. Accordingly, in the present structure, an average of the number of light's forward and backward travels within the rod becomes larger than in the first exemplary embodiment. For this reason, suppression of leakage of light at the taper rod becomes particularly important, and accordingly, the effect of the present invention is remarkably exhibited particularly in the present structure.

Further, in another exemplary embodiment, a different type of wavelength filter is provided between the phosphor and the light guiding member. This wavelength filter can transmit the fluorescence and reflect the excitation light from an LED. The other parts of the structure are the same as that in the second exemplary embodiment. A portion of the excitation light may not be absorbed but transmitted by the phosphor, but in the present structure, the transmitted portion of the excitation light can be reflected by the above-mentioned wavelength filter and then used again for excitation of the phosphor.

In still another exemplary embodiment, a wavelength filter is provided between the light guiding member and the optical filter. The wavelength filter in the present structure can transmit the fluorescence and reflect the excitation light from an LED. The other parts of the structure are the same as that in the second exemplary embodiment. Also in the present structure, the excitation light which was not absorbed but transmitted by the phosphor can be reflected by the wavelength filter and then used again for excitation of the phosphor. However, in the present structure, the excitation light is to travel backward within the taper rod after being reflected by the wavelength filter, and accordingly, a portion of it leaks out through the side surfaces of the taper rod. The taper rod of the present invention functions effectively with respect to reduction of this leakage of excitation light.

In yet another exemplary embodiment, the area of the incidence surface of the light guiding member is approximately the same as the area of the LED or the phosphor. However, the area of the incidence surface of the light guiding member is equal to or larger than the area of the LED or the phosphor. Each of the sides of the incidence surface of the light guiding member has a length in a range from the same length as that of the corresponding side of the LED to a 20% larger length. As a result, in the present structure, it is possible to make almost the whole light be incident on the taper rod even when there is fluctuation in the positional relationship between the light guiding member and the LED.

### Third Exemplary Embodiment

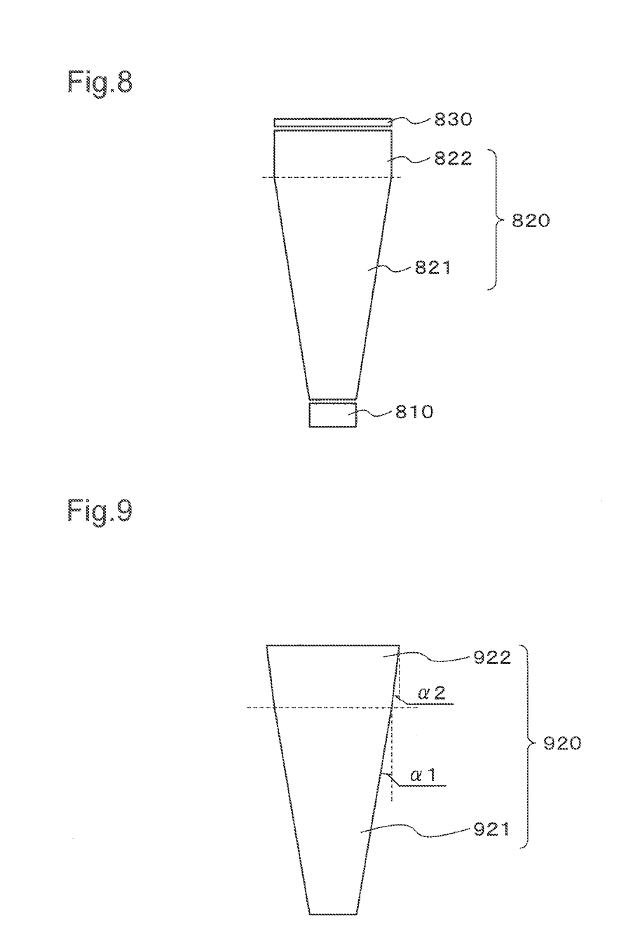

The present exemplary embodiment will be described in detail with reference to a drawing. FIG. 8 is a diagram showing a configuration of a light emitting device according to a third exemplary embodiment of the present invention.

[Description of Structure]

The third exemplary embodiment of the present invention comprises an LED 810, a light guiding member 820 and an angle filter 830. The light guiding member 820 comprises a first light guiding member 821 and a second light guiding member 822. The components are arranged to be close to each other. An antireflection coating is formed onto the both surfaces of the light guiding member and those of the angle filter. The light emission area of the LED, and the incidence and emission areas, the length and the refractive index of the light guiding member are the same as the respective ones in the first exemplary embodiment.

[Description of Operation and Effect]

The angle filter 830 in the present structure has a characteristic of transmitting light with an incident angle within a certain range but reflecting light with an incident angle beyond the range. An example of the present structure is the one described in Patent Document 4. Employed here is an angle filter which transmits light whose radiation angle into the air is within an angle range up to 15 degrees and reflects light whose radiation angle is beyond the range.

Light generated at the LED 810 travels through the light guiding member 820 and then reaches the angle filter 830. Light emitted from the LED 810 has radiation angles from 0 to 90 degrees almost following a Lambertian distribution. In the present structure, as a result of its travelling through the light guiding member 820, light is radiated from the emission surface at angles ranging from 0 to about 35 degrees. A portion of the light radiated at angles ranging from 0 to 15 degrees is transmitted by the angle filter 830, and the remaining portion radiated at other angles is reflected. The reflected light returns to the LED 810 after travelling through the light guiding member 820. This reflected light is reflected again at the LED 810. Because a textured structure is formed on the surface of the LED 810, the reflected light is scattered when it is reflected at the LED 810 and accordingly becomes of almost the same Lambertian distribution as that of when the light is emitted from the LED 810. The light reflected at the LED 810 travels again through the light guiding member 820 toward the angle filter 830. By repeating this process, almost whole light can be taken out from the angle filter 830, in the present structure.

In the present structure, light reflected by the angle filter 830 is to be reflected by the LED 810. Accordingly, light in the present structure repeatedly travels forward and backward passing through the light guiding member 820. For this reason, suppression of leakage of light at the taper rod becomes important, and accordingly, the effect of the present invention is remarkably exhibited in the present structure.

Further, in another exemplary embodiment, a diffuser plate is provided between the LED and the light guiding member. The diffuser plate in the present structure can change the angular distribution of light.

In still another exemplary embodiment, a diffraction grating is provided between the LED and the light guiding member. The diffraction grating in the present structure also can change the angular distribution of light.

In yet another exemplary embodiment, an angle filter and a reflective polarizer are provided on the side of the emission surface of the light guiding member. In this structure, it becomes possible to take out light with radiation angles ranging from 0 to 15 degrees and also with a linear polarization state.

In further another exemplary embodiment, a wavelength plate is provided between the LED and the light guiding member. The wavelength plate in the present structure can rotate the polarization state of light.

### Fourth Exemplary Embodiment

In another exemplary embodiment, a second light guiding member has a very small taper angle. FIG. 9 is a plan view of light guiding member showing a structure of a light guiding member of a light emitting device according to a fourth exemplary embodiment of the present invention.

[Description of Structure]

The light guiding member 920 in FIG. 9 comprises a first light guiding member 921 and a second light guiding member 922. As shown in FIG. 9, the second light guiding member 922 has a very small taper angle α2. Here, the taper angle α2 of the second light guiding member 922 is smaller than the taper angle of the first light guiding member 921, α1.

[Description of Effect]

Also in the present structure, leakage of light can be suppressed compared to the conventional taper rod.

### Fifth Exemplary Embodiment

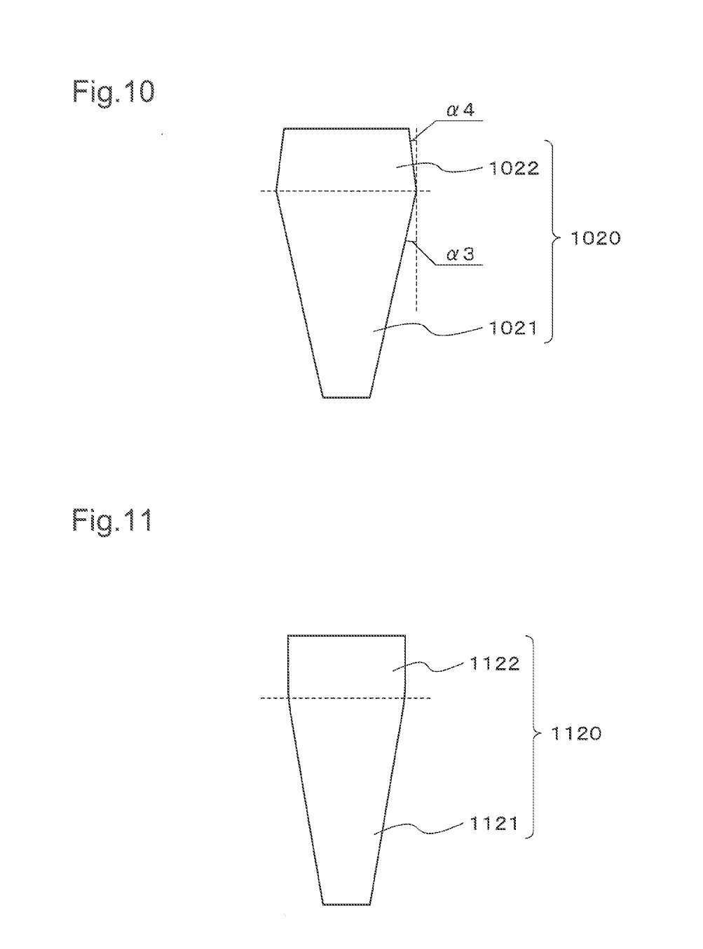

In another exemplary embodiment, a second light guiding member has a very small inverse taper angle. FIG. 10 is a plan view of light guiding member showing a structure of a light guiding member of a light emitting device according to a fifth exemplary embodiment of the present invention.

[Description of Structure]

The light guiding member 1020 in FIG. 10 comprises a first light guiding member 1021 and a second light guiding member 1022. The second light guiding member 1022 is a taper rod with an inverse taper by which the cross-sectional area is gradually decreased in the direction from the incidence side toward the emission side. As shown in FIG. 10, the second light guiding member 1022 has a very small inverse taper angle α4. Here, the inverse taper angle α4 of the second light guiding member 1022 is smaller than the taper angle of the first light guiding member 1021, α3.

[Description of Effect]

The loss increases as the inverse taper angle α4 increases, but for the case in which α4 is small as in the present exemplary embodiment, leakage of light can be suppressed compared to the conventional taper rod.

### Sixth Exemplary Embodiment

In another exemplary embodiment, the taper angle of a section for connection between a first light guiding member and a second light guiding member varies continuously in the direction from the incidence side toward the emission side. FIG. 11 is a plan view of light guiding member showing a structure of a light guiding member of a light emitting device according to a sixth exemplary embodiment of the present invention.

[Description of Structure]

The light guiding member 1120 in FIG. 11 comprises a first light guiding member 1121 and a second light guiding member 1122. As shown in FIG. 11, the taper angle of a section for connection between the first light guiding member 1121 and the second light guiding member 1122 varies continuously in the direction from the incidence side toward the emission side.

### Seventh Exemplary Embodiment

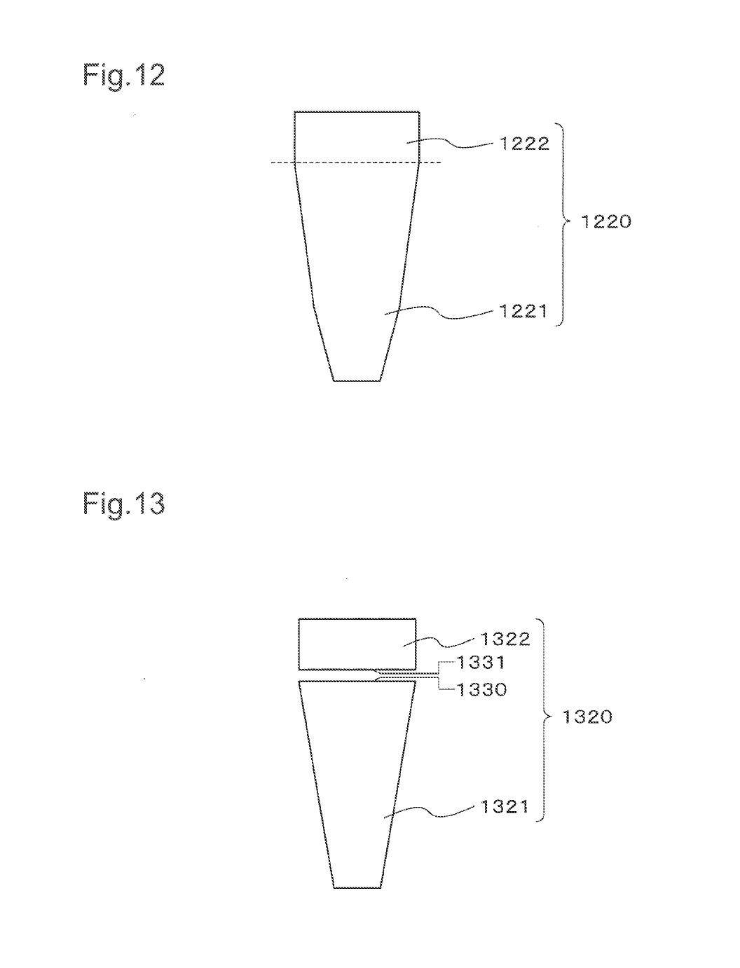

In another exemplary embodiment, the taper angle of a first light guiding member is changed by one or more steps in the direction from the incidence side toward the emission side. FIG. 12 is a plan view of light guiding member showing a structure of a light guiding member of a light emitting device according to a seventh exemplary embodiment of the present invention.

[Description of Structure]

The light guiding member 1220 in FIG. 12 comprises a first light guiding member 1221 and a second light guiding member 1222. The first light guiding member 1221 is a taper rod with a taper causing the change rate of the cross-sectional area to change once or more times in the direction from the incidence side toward the emission side. As shown in FIG. 12, the taper angle of the first light guiding member 1221 changes once or more times in the direction from the incidence side toward the emission side.

In another exemplary embodiment, the taper angle of the light guiding member continuously changes from the incidence side toward the emission side.

### Eighth Exemplary Embodiment

In another exemplary embodiment, a first light guiding member and a second light guiding member are separated from each other. FIG. 13 is a plan view of light guiding member showing a structure of a light guiding member of a light emitting device according to an eighth exemplary embodiment of the present invention.

[Description of Structure]

The light guiding member 1320 in FIG. 13 comprises a first light guiding member 1321 and a second light guiding member 1322. As shown in FIG. 13, the first light guiding member 1321 and the second light guiding member 1322 are separated from each other. Here, onto a surface of the first light guiding member 1321 and that of the second light guiding member 1322, which face each other, antireflection coatings 1330 and 1331 are formed, respectively.

Further, in another exemplary embodiment, the refractive index of the first light guiding member is different from that of the second light guiding member. That is, the first light guiding member and the second light guiding member may be made from different materials and then connected with each other.

In still another exemplary embodiment, a collimate lens is provided on the side of the emission surface of a light guiding member, and an optical filter is disposed in the vicinity of the beam waist of the collimate lens. In the present structure, light emitted from the light guiding member passes through the lens and then becomes incident on the optical filter. A portion of the light is reflected by the optical filter and then returns back to the light guiding member after passing again through the lens. Also in this structure, the effect of the rod of the present invention is exhibited.

While a variety of embodiments have been described above, it is necessary in all of the cases that a part substantially being a parallel rod is shorter than a part substantially being a taper rod, in order to suppress leakage of light more largely than in the conventional structure, that is, a structure using a rod with a wholly linear taper.

Here, if the area of the incidence surface is expressed by S1 and that of the emission surface by S2, the boundary between the substantially parallel part and the substantially taper rod can be considered to be a position for completing about 90% of the change in the area from S1 to S2, that is, a position having a cross-sectional area S calculated as

S=S1+0.9×(S2−S1)=0.9×S2+0.1×S1.

In the exemplary embodiments described above, it is assumed that the area of the incidence surface of the taper rod is the same as that of the LED or the phosphor, but these areas may be different from each other. However, from the viewpoints of the optical coupling efficiency between the components and of Etendue, it is desirable that the area of the incidence surface of the taper rod is approximately the same as that of the LED or the phosphor or the like. Here, approximately the same means that the length of each side of the incidence surface of the taper rod is different from that of the corresponding side of the LED by 10% or less at one end and 20% or less in total.

Descriptions have been given above of the exemplary embodiments of the present invention, but means for implementing the present invention are not limited to the above-described embodiments, and various modifications may be made within a range not departing from the spirit of the present invention.

This application is based upon and claims the benefit of priority from Japanese Patent Application No. 2012-066083, filed on Mar. 22, 2012, the disclosure of which is incorporated herein in its entirety by reference.

### INDUSTRIAL APPLICABILITY

The present invention relates to a hermetically sealed case comprising a cooling device for a heat generating body which is contained inside a container forming a sealed space.

### REFERENCE SIGNS LIST

110 light source
120 light guiding member
121 first light guiding member
122 second light guiding member
130 optical filter
300 parallel rod
310 incidence surface
320 emission surface
330, 335 side surface
400 taper rod
410 incidence surface
420 emission surface
430, 435 side surface
500 taper rod
510 incidence surface
520 emission surface
530, 535 side surface
600 rod
601 taper rod
602 parallel rod
610 incidence surface
620 emission surface
630, 635 side surface
710 LED
720 wavelength filter
730 phosphor
740 light guiding member
741 first light guiding member
742 second light guiding member
750 reflective polarizer
810 LED
820 light guiding member
821 first light guiding member
822 second light guiding member
830 angle filter
920 light guiding member
921 first light guiding member
922 second light guiding member
1020 light guiding member
1021 first light guiding member
1022 second light guiding member
1120 light guiding member
1121 first light guiding member
1122 second light guiding member
1220 light guiding member
1221 first light guiding member
1222 second light guiding member
1320 light guiding member
1321 first light guiding member
1322 second light guiding member
1330, 1331 antireflection coating

1. A light emitting device comprising a light source and an optical filter, the light emitting device further comprising a first light guiding member of a taper shape whose cross-sectional area is gradually increased and a second light guiding member whose flare angle is smaller than that of the taper shape of said first light guiding member, wherein the length of said second light guiding member is smaller than that of said first light guiding member.

2. The light emitting device according to claim 1, wherein said second light guiding member is of a parallel shape having a constant cross-sectional area.

3. The light emitting device according to claim 1, wherein said second light guiding member is of an inverse taper shape whose cross-sectional area is gradually decreased.

4. The light emitting device according to claim 1, wherein said first light guiding member is of a shape whose cross-sectional area changes at a rate which changes once or more times.

5. The light emitting device according to claim 1, wherein said optical filter is a reflective polarizer.

6. The light emitting device according to claim 1, wherein said optical filter is an angle filter which transmits light with an incident angle within a certain angle range but reflects light with an incident angle out of the angle range.

7. The light emitting device according to claim 1, wherein said light source is a light emitting diode.

8. The light emitting device according to claim 1, wherein said light source is a photo-excited phosphor.

9. The light emitting device according to claim 1, wherein the cross-sectional area on the incidence side of said first light guiding member is approximately the same as the light emission area of said light source.

10. The light emitting device according to claim 8, wherein between the emission side of said light guiding member and said optical filter, a wavelength filter which transmits fluorescence emitted from the photo-excited phosphor and reflects excitation light to excite the photo-excited phosphor.
